(19) United States
(12) Patent Application Publication
(10) Pub. No.: US 2021/0289586 A1
(43) Pub. Date: Sep. 16, 2021

(54) SYSTEM AND METHOD FOR CLOSED LOOP AUTOMATION BETWEEN WIFI WIRELESS NETWORK NODES

(71) Applicant: ASSIA SPE, LLC, Wilmington, DE (US)

(72) Inventor: Kenneth J. Kerpez, Long Valley, NJ (US)

(73) Assignee: ASSIA SPE, LLC, Wilmington, DE (US)

(21) Appl. No.: 17/115,012

(22) Filed: Dec. 8, 2020

Related U.S. Application Data
(60) Provisional application No. 63/023,799, filed on May 12, 2020.
(60) Provisional application No. 62/987,827, filed on Mar. 10, 2020.

(51) Int. Cl. H04W 88/12; H04W 88/18; H04W 88/16; H04W 72/04; H04W 24/10

(52) U.S. Cl. CPC H04W 88/12; H04W 88/182; H04W 24/10; H04W 72/0453; H04W 88/16

(57) ABSTRACT

Described herein are systems and methods for closed loop automation between Wi-Fi wireless network nodes. Multiple closed loops may operate among a plurality of Wi-Fi network nodes to provide management of multiple Wi-Fi access points (APs). The plurality of Wi-Fi network nodes may comprise controllers, management systems and multiple Wi-Fi APs. Multiple decision elements reside at any of the plurality of Wi-Fi network nodes and perform data collection, analysis, and provide output to one or more managed entities. The provided output optimizes performance of networks, devices, services and/or applications of the one or more managed entities. In one embodiment, a closed loop automation comprises four closed loops.

### CROSS-REFERENCE TO RELATED APPLICATIONS

This application claims priority to previously filed U.S. Application 62/987,827, filed Mar. 10, 2020, entitled “System and Method for Closed Loop Automation Between Wireless Network Nodes”, and listing Kenneth J. Kerpez as inventor, and U.S. Application 63/023,799, filed May 12, 2020, entitled “System and Method for Closed Loop Automation Between Wi-Fi Wireless Network Nodes”, and listing Kenneth J. Kerpez as inventor, which applications are hereby incorporated by reference in their entireties.

### TECHNICAL FIELD

The present disclosure described herein generally relates to the field of communication systems and more specifically to a method and system for closed loop automation of wireless network functions and segments.

### BACKGROUND

Wi-Fi communication networks have moved from simple self-configurations to managed deployments for carrier-grade Wi-Fi delivering high-quality broadband. Carrier-grade Wi-Fi can be enabled by enhanced automation and cloud-based management, diagnostics, configuration, and control.

Closed Loop Automation (CLA) has been described by ETSI Generic Autonomic Network Architecture (GANA). Closed loops operate between a network controller, a local controller, and a device or Managed Entity (ME). The closed loop is a control loop which has a controller optimizing or otherwise configuring the settings on a device, with no or minimal human or manual intervention. The closed loops may provide output to an open loop which provides information to a human user or operator. For some embodiments of closed loops as envisioned by ETSI GANA, the CLA may only be positioned between a controller (local or remote) and network elements.

Pure cloud control may have limitations. For example, cloud management and control systems may not always be reachable and cloud management and control systems may have slower reaction time than a local controller. So, more flexible combinations of closed loops can be advantageous. Also, interfaces to manage and control Wi-Fi devices from a controller have limitations such as gaps in data collection or configuration parameters. Accordingly, what are needed are systems and methods that may improve the efficiency and performance of closed loop automation between Wi-Fi wireless network elements, functions, and networks.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 depicts a flow chart illustrating a method based on functions within a closed loop between nodes according to embodiments of the present document.

FIG. 2 depicts a simplified block diagram illustrating closed loops among multiple computing levels according to embodiments of the present document.

FIG. 3 depicts a simplified block diagram illustrating a Wi-Fi multi-AP architecture and closed loops according to embodiments of the present document.

FIG. 4 depicts a simplified block diagram of a computing device/information handling system, in accordance with embodiments of the present document.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

A. Closed Loop Automation Between Wireless Network Nodes

Methods and systems for closed loop automation between wireless network nodes are described herein. A wireless network node (or simply “node”) comprises one or more of a wireless network element, wireless network function, wireless network virtual function, or wireless network segment. The wireless node may be located in any part of a wireless network.

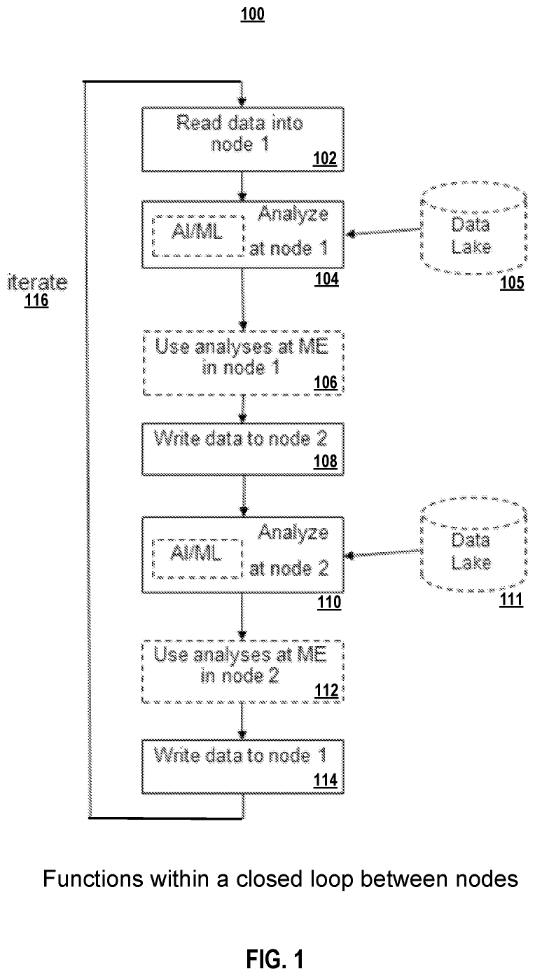

FIG. 1 depicts a flow chart 100 illustrating a method based on functions within a closed loop between nodes according to embodiments of the present document. A control loop, closed loop, CLA, or simply loop generally operates between two or more nodes, with a first node (node 1) collecting data (step 102), performing analyses (step 104), optionally uses analyses at a managed entity (ME) in node 1 (step 106) and/or outputting information (step 106). Then a second node (node 2) further collects data (step 108), performs analyses (step 110), uses analyses at a managed entity (ME) in node 2 (step 112), and/or outputs information (step 114). Then either a third node further collect data, performs analyses, and/or outputs information (not shown), or the loop re-iterates starting at the first node again (step 116). The loop may be asynchronous, with a given node operating at a different rate than another node. Loops can be fast, slow, inner, outer, hierarchical, distributed, orchestrated, configured and adapted.

Relative to FIG. 1, data is read into the ME in node 1 (step 102), such that data may include diagnostics or performance data. Then, an analyses is performed by a DE in node 1 (step 104) using that data and perhaps also data from a data lake 105, database, or data warehouse. The analyses (step 104) may include artificial intelligence (AI) or machine learning (ML) functions, for example to determine better parameter settings, or to find the cause of errors. The data may then be used at node 1 (step 106), for example to optimize parameter settings, improve performance or fix faults. Then another set of data is written to the ME in node 2 (step 108), and then analyses are performed by a DE in node 2 (step 110) using that data, and perhaps also data from a data lake 111. The data may then be used at node 2, for example to optimize parameter settings, improve performance or fix faults (step 110 and step 112). Further, another data set is written back to node 1 (step 114), thereby closing the loop. Dashed lines on figures herein indicate the function or coupling is optional. In some embodiments, the closed loop similarly operates among three or more nodes.

In some embodiments, the Decision Elements (DE) are located in wireless network nodes and closed loop automation is performed between the nodes. This may not seem to make sense since closed loop automation was originally envisioned as a straight-forward control loop between a controller with a DE and a node with a Managed Entity (ME). However, other embodiments described herein will show useful ways to perform closed loop automation between nodes. Closed loop automation may further be envisioned between nodes, functions and network segments in particularly advantageous ways. While closed loop automation operates between nodes herein, a node may contain a DE and/or data may be collected from a node, and/or the node may be configured by a DE. The closed loop may often operate iteratively, successively operating on each node in the loop.

Decision Elements (DEs) are the intelligence of a CLA. They collect data, perform analyses, and provide output. A DE can be located in any node, controller, or management system. A DE can, and often will, use Artificial Intelligence (AI) and/or Machine Learning (ML) to perform analyses and/or to generate output. While generally associated with AI or ML, a DE may alternately perform relatively simple analyses for automation. The DE output can comprise new configurations, parameter changes, notifications, alarms, instructions, information, or more data to feed to other DEs or to human operators.

A network node can contain DEs and MEs. Typically nodes with high computing power, such as computing platforms, have DEs, while nodes that are less “intelligent” have MEs. For example, a cloud computing node may have a DE, while a small Internet of Things (IoT) device has an ME. However, the wireless network nodes considered here will often have both DEs and MEs, since the nodes operate on each other in closed loops amongst themselves.

DEs and loops can be network-level, node-level, function-level, or protocol-level. The DE may interact with a ME on the same node or on another node. MEs can perform network functions themselves while receiving input from MEs. DEs can operate in the control plane or intelligence plane. MEs can operate in the data plane or user plane.

A function within a node may serve as both a DE and an ME. For example, an ML function may serve as a DE that feeds the output of a pattern recognition model to an ME in another node in a lower loop, while that same function also serves as an ME by receiving model coefficients or model structure calculated by a DE in a node in an upper loop.

Closed loops may perform optimization of networks, devices, services or applications. The closed loops may perform diagnostics and may identify faults or areas of low performance. The closed loops may perform network re-configuration toward improving or optimizing performance. The closed loops may provide output to an open loop which provides information to a human user or operator. Closed loops may implement functions or services related to fault, configuration, accounting, performance monitoring, provisioning, network planning, or security. Closed loops may implement functions or services including resource allocation, traffic prediction, quality of experience (QoE) assessments, assignments for quality of service (QoS), route planning, spectrum management, fault diagnostics, root cause, fault correlation, and network optimization.

Multiple closed loops can run in coordination with each other, for example for joint optimization between loops. A first loop diagnoses and configures a particular network domain (e.g., a network segment, function or service). Then, this is further iterated on by a second loop, which diagnoses and configures a different domain. Many such loops can run together, altogether this creates a unique type of distributed system. The multiple loops may be explicitly coordinated, e.g., by an orchestrator or controller. Or the multiple loops may only implicitly operate together by the interactions between their domains.

B. Virtual Function Nodes

Virtualization is becoming popular, with network functions running in the cloud, data center, network edge, or on hosting platforms in devices. A combination of virtualization platforms can be used, such as with fog computing. Cloud can comprise all such virtualized platforms. There can be multiple types of computing associated with a wireless network, including virtualized functions, bare metal servers, and on devices themselves.

A virtual network function (VNF) runs on virtual computing infrastructure such as a cloud, data center, or edge computing platform. VNFs generally serve as DEs, but can also be MEs. VNFs can be controlled and managed by one or more of an orchestrator, VNF manager (VNFM), virtual infrastructure manager (VIM), software defined network (SDN) controller, or SDN management and control (M&C). Often there is a collection of physical nodes or physical network functions (PNFs) such as network elements, and an associated collection of virtual functions or nodes, with the virtual functions located remotely. Physical functions may operate on network elements (NEs) or devices in the network, with virtual functions operating on virtual computing infrastructure such as a cloud, data center, or edge computing platform. Virtual functions can also be hosted on network elements or devices such as user equipment (UE). Physical functions may operate on the data plane, with virtual functions operating on the control plane. Nodes can be physical or virtual, or encompass both physical and virtual functions.

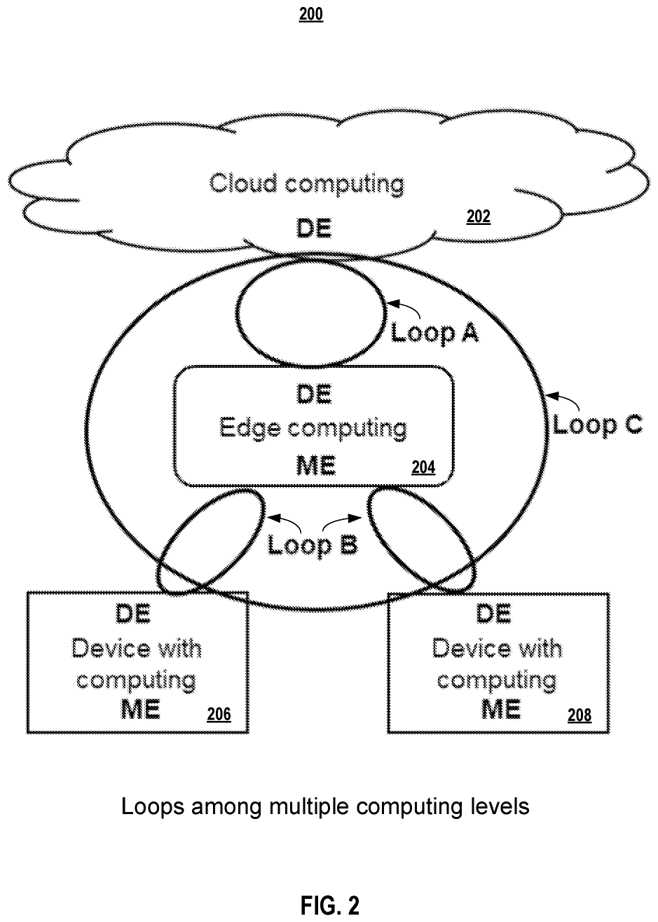

FIG. 2 depicts a simplified block diagram 200 illustrating closed loops among multiple computing levels according to embodiments of the present document. Loop A runs between a cloud computing node 202 and an edge computing node 204. Loop B runs between an edge computing node 204 and a device, either device 206 or device 208, which have local computing. Loop C runs between a cloud computing node 202 and devices 206/208, which have local computing. Any of these loops may contain DEs or MEs.

A node can comprise physical functions and virtual functions. Closed loops can operate between groups of physical functions and virtual functions or amongst a set of physical functions and virtual functions. In other words, A DE can be a PNF or a VNF.

A node can interact with an orchestration system, management system, database, data lake, data warehouse, and big data. Or a node may encompass a database, data lake, data warehouse, or big data. A CLA can operate over long timescales between a node and a database, data lake, data warehouse, or big data.

C. Wi-Fi Wireless

Closed loop automation, as described herein, can be performed among nodes of a wireless communication network. Wi-Fi wireless communication encompasses Wireless Local Area Networking (WLAN), including all types of IEEE 802.11 Wi-Fi and Wi-Fi Alliance CERTIFIED systems and methods.

Multi-AP management improves Wi-Fi coverage. The hierarchy of local and cloud management presented in this use case provides a platform for distributed intelligence to optimize the user's Wi-Fi experience. For example, AI in cloud management can analyze large datasets to determine optimal channel assignments and station associations for combinations of time-of-day and traffic demands across multiple multi-AP domains. AI in EasyMesh controllers, as specified by the Wi-Fi Alliance, can complement cloud management with rapid reactions.

For Wi-Fi wireless networks, cloud management can provide automation benefits.
Cloud management and control assists with operations automation. In addition to managing the individual customer, cloud-based management also allows for opportunities to manage all customers in a given area holistically to deliver better Wi-Fi performance for all customers. Multiple Wi-Fi and Multi-AP domains can be simultaneously managed, for example to minimize interference between domains.
Cloud management and control systems can dedicate much more computational and storage resources to monitoring, diagnostics, and optimization functions than individual network elements, enabling high-power AI-based analyses. In particular, large datasets can be used.
Cloud management and control systems may not always be reachable and cloud management and control systems may have slower reaction time than a local controller; in these cases some local control helps. For example, a local controller can react fast enough to change station association without interrupting a voice call. AI in cloud controllers can complement local controllers by using more compute power and large datasets. So, different control loops, operating across a LAN or across the WAN, can have complementary uses.
This use case describes multiple closed loops for automation (CLA) of Wi-Fi management and control. Some of these loops may or may not be used, and they may be used independently or in coordination. Moreover, the specifications for the control, agents, and their interfaces may be based on Wi-Fi Alliance (WFA) Wi-Fi CERTIFIED EasyMesh™).

D. Example Embodiment: Wi-Fi

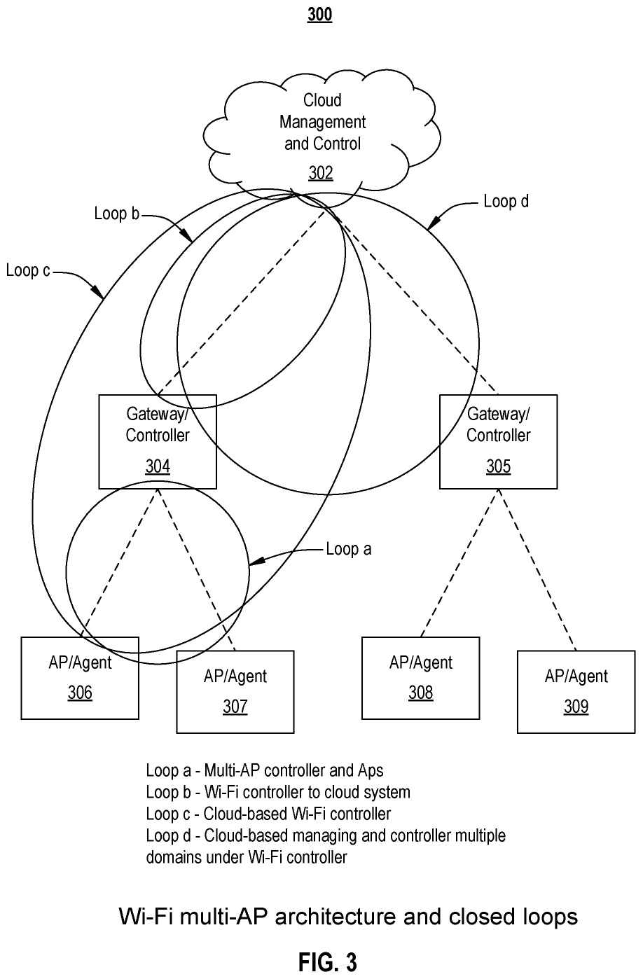

FIG. 3 depicts a simplified block diagram 300 illustrating a Wi-Fi multi-AP architecture and closed loops according to embodiments of the present document. Effectively, FIG. 3 shows an example embodiment of closed loops with Wi-Fi network nodes. The embodiment comprises multiple closed loops for automation (CLA) of Wi-Fi management and control, with particular management of multiple Wi-Fi Access Points (APs). The hierarchy of local and cloud management presented in this use case can provide a platform for distributed intelligence to optimize the user's Wi-Fi experience.

There are four closed loops in FIG. 3 as described in the following paragraphs. The dashed lines on FIG. 3 indicates the coupling is optional.

In some embodiments, Loop a implements a local Multi-AP controller interacting with APs. This uses a controller 304 to manage a multi-AP domain, with an agent in each AP (e.g., AP/Agent 306, AP/Agent 307), and perform channel assignment and station steering, etc. The controller 304 resides on a device in the premises and communicates with agents. Controller 304 may be located at a gateway.

In some other embodiments, Loop a implements Wi-Fi Alliance (WFA) CERTIFIED EasyMesh™. This embodiment uses an EasyMesh controller to manage a multi-AP domain, perform channel assignment and station steering, etc. The EasyMesh controller resides on a device in the premises and communicates with EasyMesh agents. Relative to FIG. 3, controller 304 and controller 305 may be EasyMesh Controllers, and AP/Agent 306/307/308/309 may be EasyMesh Agents.

In some embodiments, Loop b is between a controller 304 and a cloud management and control system 302. In loop b, the controller 304 can provide data to the cloud management and control system 302. The cloud management and control system 302 further manages and refines the diagnostics and control which are performed by the controller 304. In particular, the cloud management and control system 302 can use long-term historical data.

In some other embodiments, Loop b is between an EasyMesh controller and a cloud management and control system. In this loop the EasyMesh controller can serve as a Wi-Fi Alliance (WFA) CERTIFIED Data Elements™ agent, with the cloud management and control system being a Data Elements collector. The cloud management and control system further refines the diagnostics and control which are performed by the EasyMesh controller; in particular the cloud management and control system can use long-term historical data.

In some embodiments, Loop c has the cloud management and control system 302 acting as a controller, or equivalently using a cloud-based controller. Loop c may be coupled between cloud management and control system 302, and AP/Agent 306 and/or AP/Agent 307.

In some other embodiments, Loop c has the cloud management and control system acting as an EasyMesh controller, or equivalently using an EasyMesh cloud controller as presented in more detail in Broadband Forum CloudCO-APPN-436.

In some embodiments, Loop d comprises the cloud management and control system 302 managing and controlling multiple domains under controllers. The cloud management and control system 302 can, for example, assign channels that may or may not be used in each multi-AP domain to avoid interference. Loop d may be coupled between cloud management and control system 302 and controller 304 and controller 305. Controller 304 and controller 305 may be located at a gateway. Controller 305 maybe coupled to AP/Agent 308 and AP/Agent 309.

In some other embodiments, Loop d has the cloud management and control system managing and controlling multiple domains under EasyMesh controllers. Here the cloud management and control system can, for example, assign channels that may or may not be used in each multi-AP domain to avoid interference

Additional closed loops may extend into a Wide Area Network (WAN). For example broadband access lines or network elements, such as access nodes, can be in an additional loop with Wi-Fi cloud, controller, or AP. Access nodes can be Digital Subscriber Line Access Multiplexers (DSLAMs), Optical Line terminals (OLTs), Ethernet switches, Cable Modem Termination Systems (CMTS), or similar. There can also be a closed loop with the broadband aggregation network.

In some embodiments, a method of closed loop automation may be applied to a wireless communications network. One or more closed loops may operate among a plurality of wireless network nodes, wherein each wireless network node may comprise one or more of a wireless network function, wireless control function, wireless network element, or wireless network segment. Data collection, analysis, and output may be performed by multiple decision elements. One or more decision element may not be a controller. Moreover, the decision elements may reside in multiple wireless network nodes and the decision elements may provide data to one or more managed entities, and the provided data may affect the operation of the managed entities. The analysis may involve artificial intelligence or machine learning. A closed loop operates on a managed entity (ME).

In other embodiments, a method of closed loop automation may be applied to a Wi-Fi network, wherein multiple closed loops operate among a plurality of wireless network nodes, and wherein data collection, analysis, and output are performed by multiple decision elements. The decision elements may reside in multiple wireless network nodes, the decision elements may provide data to one or more managed entities, and the provided data may affect the operation of the managed entities. The closed loops may comprise: i) a loop between a local multi-access point (multi-AP) controller and one or more access points (APs), ii) a loop between a local multi-access point (multi-AP) controller and a cloud management and control system, iii) a loop between a cloud management and control system and one or more access points (APs), and iv) a loop between a cloud management and control system and more than one local multi-access point (multi-AP) controller.

The multiple closed loops may operate and interact in a coordinated manner, wherein the interaction in a coordinated manner forms a distributed system. A closed loop may further provide output to an open loop that may provide information to a human user or operator. There can be multiple layers of computing, including one or more of cloud computing, edge computing, and local computing on a device. A wireless network node may comprise virtual functions or physical functions. A closed loop operates between a physical function and a virtual function. A closed loop operates amongst a set of physical functions and virtual functions.

The method may further involve interaction with one or more of: an orchestrator, virtual network functions manager, Software-defined network (SDN) controller SDN management and control, a database, a data lake, a data warehouse, or big data.

A closed loop may operate for one or more of the following purposes: optimization of networks, devices, services or applications, diagnostics, identification of faults, identification of areas of low performance, fault management, fault correlation, configuration, accounting, performance monitoring, provisioning, network planning, security, resource allocation, traffic prediction, quality of experience (QoE) assessments, assignments for quality of service (QoS), route planning, spectrum management, root cause determination, or network optimization.

E. System Embodiments

In embodiments, aspects of the present patent document may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

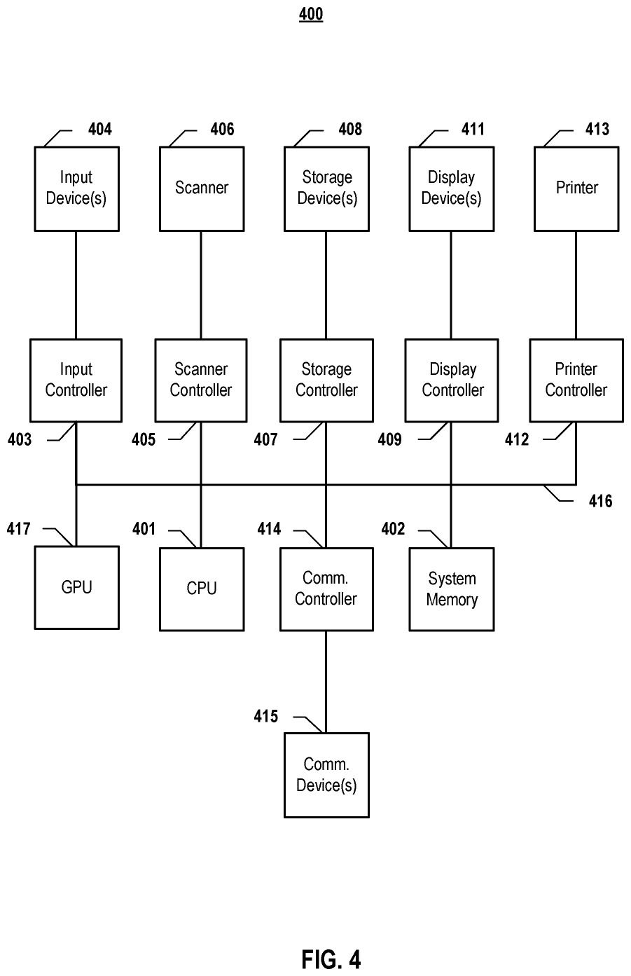

FIG. 4 depicts a simplified block diagram of a computing device/information handling system 400 (or computing system) according to embodiments of the present disclosure. It will be understood that the functionalities shown for system 400 may operate to support various embodiments of an information handling system—although it shall be understood that an information handling system may be differently configured and include different components.

As illustrated in FIG. 4, system 400 includes one or more central processing units (CPU) 401 that provides computing resources and controls the computer. CPU 401 may be implemented with a microprocessor or the like, and may also include one or more graphics processing units (GPU) 417 and/or a floating point coprocessor for mathematical computations. System 400 may also include a system memory 402, which may be in the form of random-access memory (RAM), read-only memory (ROM), or both.

A number of controllers and peripheral devices may also be provided, as shown in FIG. 4. An input controller 403 represents an interface to various input device(s) 404, such as a keyboard, mouse, or stylus. There may also be a scanner controller 405, which communicates with a scanner 406. System 400 may also include a storage controller 407 for interfacing with one or more storage devices 408 each of which includes a storage medium such as magnetic tape or disk, or an optical medium that might be used to record programs of instructions for operating systems, utilities, and applications, which may include embodiments of programs that implement various aspects of the present invention. Storage device(s) 408 may also be used to store processed data or data to be processed in accordance with the invention. System 400 may also include a display controller 409 for providing an interface to a display device 411, which may be a cathode ray tube (CRT), a thin film transistor (TFT) display, or other type of display. The computing system 400 may also include a printer controller 412 for communicating with a printer 413. A communications controller 414 may interface with one or more communication devices 415, which enables system 400 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 416, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

Computing system 400 may be virtualized and hosted in a data center, on virtual machines, or hosted in containers. Then, blocks 401-417 may be embodied as virtual functions or network services instead of being part of a single physical system or bare-metal system.

One skilled in the art will recognize no computing system or programming language is critical to the practice of the present invention. One skilled in the art will also recognize that a number of the elements described above may be physically and/or functionally separated into sub-modules or combined together. It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A controller comprising:
a plurality of closed loop interfaces coupled to a cloud management and control and a plurality of Wi-Fi network nodes, the plurality of closed loop interfaces receives data from the plurality of Wi-Fi network nodes related to performance aspects of at least one of the Wi-Fi network nodes within the plurality of Wi-Fi network nodes;
a decision element communicatively coupled to the controller, the decision element analyzes the received data from the plurality of closed loop interfaces and generates a control signal having at least one operation command that improves a performance of at least one Wi-Fi network node; and
wherein the at least one operation command is transmitted to a first managed entity within the at least one Wi-Fi network node, the first managed entity modifies an action of the at least one Wi-Fi network node in accordance with the at least one operation command.

2. The controller of claim 1 wherein the first managed entity is an Access Point

3. The controller of claim 1 wherein the first managed entity is a gateway.

4. The controller of claim 1 wherein the decision element is located within the controller.

5. The controller of claim 1 wherein the decision element is located externally to the controller.

6. The controller of claim 1, wherein the decision element assigns channel information for the at least one Wi-Fi network node.

7. The controller of claim 1, wherein the configuration provided by the controller includes at least one of channel assignments and station steering.

8. The controller of claim 1, wherein a first closed loop interface within the plurality of closed loop interfaces receives additional data that is provided to the decision element, the decision element generates an additional operation command that further modifies the at least one Wi-Fi network node.

9. The controller of claim 1, wherein a first closed loop interface within the plurality of closed loop interfaces receives diagnostics and control information from a second controller, the first closed loop interfaces transmits diagnostics and control information to the at least one Wi-Fi network node.

10. The controller of claim 1, wherein the decision element uses Artificial Intelligence (AI) and/or Machine Learning (ML) to perform analyses and/or to generate output.

11. The controller of claim 1, wherein the at least one operation command comprises at least one of a new configuration, a parameter change, a notification, an alarm, and an instruction.

12. The controller of claim 1, wherein the decision element performs operations comprising at least one of identification of faults, identification of areas of low performance, fault management, fault correlation, configuration, accounting, performance monitoring, provisioning, network planning, security, resource allocation, traffic prediction, quality of experience (QoE) assessments, assignments for quality of service (QoS), route planning, spectrum management, root cause determination, or network optimization.

13. The controller of claim 1, wherein the decision element comprises a virtual function that runs in a cloud or edge computing platform.

14. A closed loop system comprising:
at least one decision element residing at one or more of a plurality of Wi-Fi network nodes, the plurality of Wi-Fi network nodes comprising cloud management and control, a plurality of gateway controllers and a plurality of access point/agents, the at least one decision element generates at least one operation command generated based on an analysis of collected data received from a plurality of closed loops within the closed loop system;
at least one managed entity coupled to the at least one decision element, the at least one managed entity receives the at least one operation command from the at least one decision element, and
wherein the at least one operational command improves performance of networks, devices, services and/or applications of the at least one managed entity based on the received at least one operation command.

15. The system of claim 14, wherein the at least one operation command provided by the at least one decision element comprises at least one of channel assignments and station steering

16. The system of claim 14, wherein the at least one decision element analysis of collected data utilizes historical data that are further refined by a second access point controller within a first closed loop within the plurality of closed loops, and a cloud management and control in a second closed loop within the plurality of closed loops.

17. The system of claim 14, wherein the at least one decision element receives diagnostics and control information from a second decision element, the first decision element and the second decision element being located within a closed loop within the plurality of closed loops.

18. A method for closed loop automation (CLA) operating between a plurality of wireless nodes comprising the following steps:
transmitting a first operation command from cloud management and control node, the first operation command being generated from a first data set received on a first closed loop;
transmitting a second operation command from a first local controller, the second operation command being generated from a second data set received on a second closed loop;
receiving, at a first local controller, the first operation command on the first closed loop;
receiving, at an access point, the second operation command on the second closed loop; and
initiating a parameter change at the access point based on the first and second operation commands, the parameter change improving a network performance related to the access point.

19. The method of claim 18, wherein the first operation commend from cloud management and control node is generated by a decision element located at the cloud management and control node, the decision element communicating the operation command to a managed entity on first controller gateway.

20. The method of claim 19, wherein a decision element located on the first controller gateway generates the second operation command transmitted to a managed entity located on the access point.
